(19) United States
(12) Patent Application Publication
(10) Pub. No.: US 2004/0034877 A1
(43) Pub. Date: Feb. 19, 2004

(54) Method and apparatus for qam tuner sharing between dtv-pvr and cable-modem aplication

(76) Inventor: Thomas Nogues, Twickenham TW1 1 AG (GB)

Correspondence Address: LADAS & PARRY, 26 WEST 61ST STREET, NEW YORK, NY, 10023, US

(21) Appl. No.: 10/221,609

(22) PCT Filed: Jan. 4, 2002
(86) PCT No.: PCT/GB02/00030

(30) Foreign Application Priority Data
Jan. 18, 2001 (GB) 0101338.2

(51) Int. Cl. H04N 7/16

(52) U.S. Cl. 725/151; 725/110

(57) ABSTRACT

A set-top box (STB) in a subscriber unit of a combined digital television and communication system is described. The STB includes a controller and a quadrature amplitude modulation (QAM) based tuner operatively controlled by the controller to selectively enable shared use of the QAM based tuner between the following two functions: tuning to a digital television frequency; and providing a downstream cable-modem link. Related apparatus and methods are also described.

### FIELD OF THE INVENTION

The present invention relates generally to combined digital television and communication systems.

### BACKGROUND OF THE INVENTION

Today, operators of digital television (DTV) systems are striving to add new services and applications in order to increase their revenues and to attract new subscribers. Some of the new services and applications demand new capabilities such as a personal video recording (PVR) capability and a capability to perform fast downloading of data provided by a broadband communication network.

Manufacturers of set-top boxes (STBs) are today tending to respond to such challenges by adding a separate tuner for each required capability. However, adding separate tuners for the PVR capability and the capability to perform fast downloading of broadband data results in complex STB configurations and expensive STB hardware. A simpler and less expensive solution is therefore required.

Some aspects of technologies that may be useful in understanding the present invention are described in the following publications:

chapter 4 on pages 161-214 in a book entitled Modern Cable Television Technology, by Walter Ciciora, James Farmer and David Large, Morgan Kaufmann Publishers, Inc., San Francisco, Calif.

European Telecommunication Standard: Digital Video Broadcasting (DVB); DVB Interaction Channel for Cable TV Distribution Systems (CATV), ETS 300 800, a draft dated Mar. 8, 1999; and

Data-Over-Cable-Service-Interface-Specification (DOCSIS); Radio Frequency Interface Specification, SP-RFI v1.1-101-990311, dated Mar. 11, 1999.

U.S. Provisional Patent Application 60/262,936 of Nogues and UK Provisional Patent Application 0101338.2, the disclosures of which are hereby incorporated herein by reference, describe an STB with QAM (Quadrature Amplitude Modulation) demodulator sharing between DTV/PVR and cable modem applications.

Published PCT application WO 00/01149 and the corresponding U.S. patent application Ser. No. 09/515,118 to Wachtfogel et al describe a digital television recording method comprising: broadcasting a television program associated with a broadcaster set of parameters enabling access to a first set of predetermined portions of the program; operating an agent for determining whether to record the program and for associating with the program, upon recording of the program, an agent set of parameters enabling access to a second set of predetermined portions of the program; storing the program together with the broadcaster set of parameters and the agent set of parameters to generate an addressable program; retrieving at least a portion of the addressable program; displaying the at least a portion of the addressable program to a user; receiving from the user a user set of parameters enabling access to a third set of predetermined portions of the addressable program; editing the addressable program to include the user set of parameters enabling access to the third set of predetermined portions of the addressable program thereby generating an edited addressable program; and storing the edited addressable program.

A system entitled XTV™ which is commercially available from NDS Ltd., of One London Road, Staines, Middlesex, UK implements PVR capabilities.

U.S. Pat. No. 5,774,527 of Handelman et al describes integrated telephone and cable communication networks.

The disclosures of all references mentioned above and throughout the present specification are hereby incorporated herein by reference.

### SUMMARY OF THE INVENTION

The present invention, in preferred embodiments thereof, seeks to enable a subscriber unit of a combined digital television and communication system to utilize digital television applications and downstream broadband communication applications by sharing a single quadrature amplitude modulation (QAM) based tuner.

In preferred embodiments of the present invention, a single QAM based tuner in a set-top box (STB) in the subscriber unit is controlled to selectively enable shared use of the QAM based tuner between the following two functions: tuning to a digital television frequency; and providing a downstream cable-modem link. The downstream cable-modem link may be utilized by a cable-modem to enable downstream communication via the downstream cable-modem link when the QAM based tuner is enabled to provide the downstream cable-modem link. The cable-modem may be used, for example, either with the Data Over Cable Service Interface Specification (DOCSIS) standard or the Digital Video Broadcasting Return Channel (DVB_RC) standard.

There is thus provided in accordance with a preferred embodiment of the present invention an STB in a subscriber unit of a combined digital television and communication system, the STB including a controller, and a QAM based tuner operatively controlled by the controller to selectively enable shared use of the QAM based tuner between the following two functions: tuning to a digital television frequency, and providing a downstream cable-modem link.

Preferably, the function of tuning to a digital television frequency includes one of the following: tuning to a first digital television program for enabling viewing of the first digital television program by a user of the subscriber unit, and tuning to a second digital television program for recording the second digital television program by the user of the subscriber unit. The first digital television program and the second digital television program may be identical.

The STB may also preferably include an additional QAM based tuner operative to tune to a third digital television program for enabling viewing of the third digital television program by a user of the subscriber unit.

Additionally, the STB may also include a storage device operative to store the second digital television program when the QAM based tuner is tuned to the second digital television program.

Further additionally, the STB may also include a cable-modern operatively associated with the QAM based tuner and operative to enable downstream communication via the downstream cable-modem link when the QAM based tuner is enabled to provide the downstream cable-modem link.

Still further additionally, the STB may also include a quadrature phase shift keying (QPSK) based modulator operative to enable a report back of an indication of availability resources of the QAM based tuner by upstream transmission to at least one of the following: a headend of the combined digital television and communication system, and a broadband communication network in the combined digital television and communication system.

The indication of availability resources may include an indication indicating whether the QAM based tuner is currently available and/or an indication indicating a time period within which the QAM based tuner is expected to be available. In a case where the STB includes the storage device, the indication of availability resources may also include an indication indicating an available storage capacity of the storage device.

Preferably, each one of the first digital television program and the second digital television program is received at the STB in a compressed form, and the STB also includes a decompressor operatively associated with the QAM based tuner and operative to decompress each one of the first digital television program and the second digital television program. The decompressor may include a Moving Picture Expert Group (MPEG) based decompressor.

The controller is preferably operative generate a message indicating that the downstream cable-modem link cannot be used while the QAM based tuner is tuned to the second digital television program, and a message indicating that the second digital television program cannot be recorded while the QAM based tuner is enabled to provide the downstream cable-modem link.

Further in accordance with a preferred embodiment of the present invention there is provided an STB in a subscriber unit of a combined digital television and communication system, the STB including a first QAM based tuner operative to tune to a digital television program for enabling viewing of the digital television program by a user of the subscriber unit, a controller, and a second QAM based tuner operatively controlled by the controller to selectively enable shared use of the second QAM based tuner between the following two functions: recording the digital television program, and providing a downstream cable-modem link.

Still in accordance with a preferred embodiment of the present invention there is provided a combined digital television and communication system including a headend operative to broadcast digital television programs, a broadband communication network operative to transmit a downstream cable-modem application, and a multiplicity of subscriber units, each including a first QAM based tuner operative to tune to a first digital television program of the digital television programs broadcast by the headend, a decompressor operatively associated with the first QAM based tuner and operative to decompress the first digital television program prior to displaying of the first digital television program on a display, a controller, a second QAM based tuner operatively controlled by the controller to selectively enable shared use of the second QAM based tuner between the following two functions: tuning to a second digital television program of the digital television programs broadcast by the headend for recording the second digital television program, and tuning to the downstream cable-modem application, a cable-modem operative to enable use of the downstream cable-modem application when the second QAM based tuner is tuned to the downstream cable-modem application, and a storage device operative to store the second digital television program when the second QAM based tuner is tuned to the second digital television program.

The first digital television program and the second digital television program may be identical.

Preferably, each of the multiplicity of subscriber units also includes a QPSK based modulator operative to enable a report back of an indication of availability resources of the second QAM based tuner by upstream transmission to at least one of the following: the headend, and the broadband communication network.

The headend is preferably operative, upon receiving the report back from at least one the controller, to program the at least one the controller to tune the second QAM based tuner to the second digital television program for storing the second digital television program.

There is also provided in accordance with a preferred embodiment of the present invention a method for use with an STB in a subscriber unit of a combined digital television and communication system, the method including selectively enabling shared use of a QAM based tuner between the following two functions: tuning to a digital television frequency, and providing a downstream cable-modem link.

Preferably, the function of tuning to a digital television frequency includes one of the following: tuning to a first digital television program for enabling viewing of the first digital television program by a user of the subscriber unit, and tuning to a second digital television program for recording the second digital television program by the user of the subscriber unit.

Additionally, the method may also include storing the second digital television program when the QAM based tuner is tuned to the second digital television program. In such a case, the method may also include displaying a message indicating that the downstream cable-modem link cannot be used during the storing.

Further additionally, the method may also include enabling downstream communication via the downstream cable-modem link when the QAM based tuner is enabled to provide the downstream cable-modem link. In such a case, the method may also include enabling usage of the downstream cable-modem link when the QAM based tuner is enabled to provide the downstream cable-modem link, and displaying a message indicating that the second digital television program cannot be recorded while the downstream cable-modem link is used.

The method may also include, regardless of whether the QAM based tuner is tuned to a digital television frequency or provides the downstream cableWO modem link, enabling a report back of an indication of availability resources of the QAM based tuner to at least one of the following: a headend of the combined digital television and communication system, and a broadband communication network in the combined digital television and communication system.

The indication of availability resources preferably includes at least one of the following: an indication indicating whether the QAM based tuner is currently available, an indication indicating a time period within which the QAM based tuner is expected to be available, and an indication indicating an available storage capacity of a storage device within which a digital television program accessed when the QAM based tuner is tuned to the digital television frequency can be stored.

Also in accordance with a preferred embodiment of the present invention there is provided a method for use with an STB in a subscriber unit of a combined digital television and communication system, the method including tuning a first QAM based tuner to a digital television program for enabling viewing of the digital television program by a user of the subscriber unit, and selectively enabling shared use of a second QAM based tuner between the following two functions: recording the digital television program, and providing a downstream cable-modem link. The method may additionally include decompressing the digital television program.

### BRIEF DESCRIPTION OF THE DRAWINGS

The present invention will be understood and appreciated more fully from the following detailed description, taken in conjunction with the drawings in which:

FIG. 1 is a simplified partly pictorial partly block diagram illustration of a combined digital television and communication system constructed and operative in accordance with a preferred embodiment of the present invention;

FIG. 2 is a simplified block diagram illustration of a preferred implementation of a set-top box (STB) in a subscriber unit (SU) in the system of FIG. 1; and

FIGS. 3A-3C together comprise a simplified flowchart illustration of a preferred method of operation of the apparatus of FIG. 2 in the system of FIG. 1.

### DETAILED DESCRIPTION OF A PREFERRED EMBODIMENT

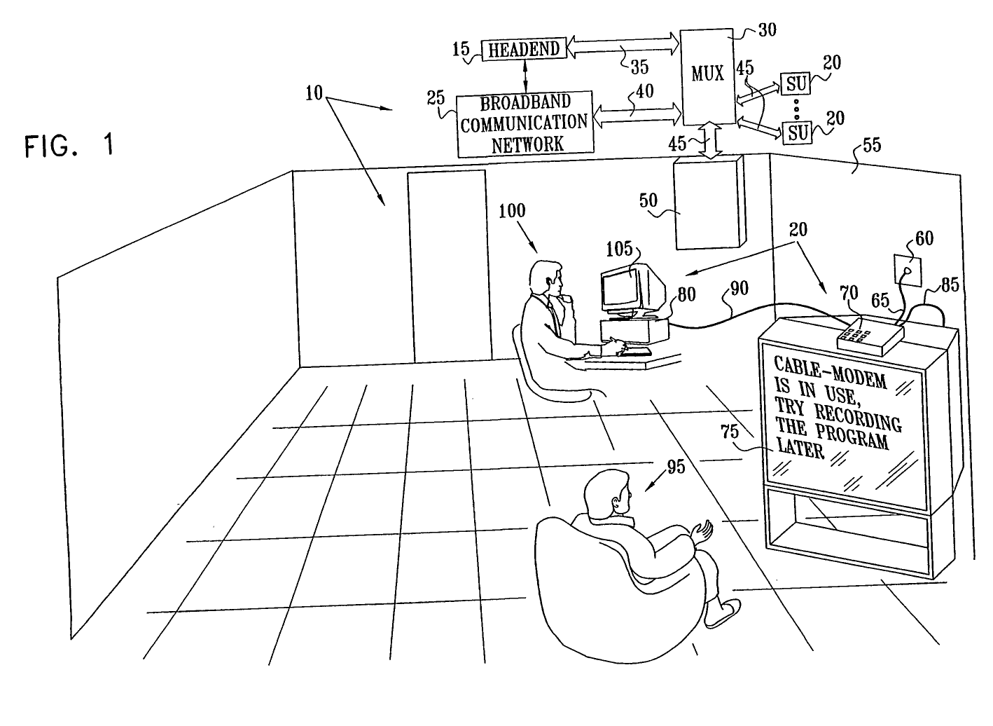

Reference is now made to FIG. 1 which is a simplified partly pictorial partly block diagram illustration of a combined digital television and communication system 10 constructed and operative in accordance with a preferred embodiment of the present invention.

Preferably, the system 10 includes at least one headend 15 that transmits digital television programs, preferably including pay television programs, to a plurality, typically a multiplicity, of subscriber units (SUs) 20, and a broadband communication network 25 that communicates with the SUs 20 via broadband communication links. The broadband communication network 25 may be implemented by an appropriate network or a combination of appropriate networks well known in the art, such as, but not limited to, at least one of the following: a local-area-network (LAN); a metropolitan-area-network (MAN); and a wide-area-network (WAN).

The headend 15, the broadband communication network 25 and the SUs 20 may preferably communicate via appropriate infrastructure. The infrastructure may include any appropriate combination of coaxial cables, satellite, telephone wires, fiber optic cables, cellular infrastructure, and wireless infrastructure, or any other suitable infrastructure. It is appreciated that the present invention is not limited by the type of infrastructure used in the system 10.

By way of example, the system 10 in FIG. 1 is implemented by infrastructure that includes coaxial cables for communicating the digital television programs and data to the SUs 20. In such a case, a multiplexer/demultiplexer (MUX/DEMUX) unit 30 may preferably multiplex headend transmissions provided by the headend 15 and broadband transmissions provided by the broadband communication network 25 to provide multiplexed transmissions to each SU 20 over one or more coaxial cables 45. The headend transmissions and the broadband transmissions are preferably provided over coaxial cables 35 and 40 respectively.

Each coaxial cable 45 may be in operative association with a distribution board 50 that may be installed at, or nearby, a subscriber residence or office in which a corresponding SU 20 is housed. For simplicity of depiction and description, and without limiting the generality of the foregoing, a detailed illustration of only one SU 20 at a single subscriber residence 55 is shown in FIG. 1.

Preferably, the multiplexed transmissions are carried over coaxial cables (not shown) emanating from the distribution board 50 and passing through walls at the subscriber residence 55. These coaxial cables are typically terminated by at least one coaxial cable wall outlet 60 that can feed, for example via a coaxial cable 65, a coaxial cable appliance such as a set-top box (STB) 70 that is comprised in the SU 20. The STB 70 is preferably in operative communication with a television 75 and a computer 80, which are also preferably comprised in the SU 20, via respective cables 85 and 90 or any other appropriate means, such as wireless transmitters and receivers (not shown). The television 75 may preferably display the headend transmissions portion of the multiplexed transmissions and the computer 80 may preferably process the broadband transmissions portion of the multiplexed transmissions.

It is appreciated that the television 75 and the computer 80 may be operated by different users of the SU 20. For example, a first user 95 may view programs on the television 75 and a second user 100 may run applications on the computer 80.

The operation of the system 10 is now briefly described. Preferably, digital television applications broadcast from the headend 15 and broadband applications transmitted via the broadband communication network 25 are multiplexed by the MUX/DEMUX unit 30 to form multiplexed transmissions. The multiplexed transmissions are then transmitted to the SU 20 at the subscriber residence 55.

Preferably, the STB 70 at the SU 20 receives the multiplexed transmissions via the wall outlet 60 and the coaxial cable 65. The STB 70 may then selectively enable sharing between the following two functions: tuning to a digital television frequency; and providing a broadband downstream link. When the broadband downstream link is provided, a broadband communication element in the STB 70, such as a cable-modem (not shown in FIG. 1), may use the broadband downstream link to enable downstream communication with the computer 80 thereby enabling the computer 80 to display and/or process information transmitted thereto downstream. Throughout the specification and claims the term “downstream” refers to a direction of communication from the broadband communication network 25, or the headend 15, towards the SU 20, and the term “upstream” refers to a direction of communication from the SU 20 towards the broadband communication network 25, or the headend 15.

The function of tuning to a digital television frequency may preferably include one of the following: tuning to a first digital television program for enabling viewing of the first digital television program by the user 95 of the SU 20; and tuning to a second digital television program for recording the second digital television program in a storage device (not shown in FIG. 1) in the STB 70 by the user 95 of the SU 20. In accordance with a preferred embodiment of the present invention when tuning to the second digital television program is enabled, the STB 70 may enable, in an optional preferred configuration, simultaneous tuning to a third digital television program for enabling viewing of the third digital television program by the user 95.

Thus, in a configuration in which the STB 70 does not enable simultaneous tuning to the third digital television program, the STB 70 may enable only one of the following combinations:

(1) Tuning only to the first digital television program for enabling viewing of the first digital television program by the user 95. In such a case, the user 100 cannot use the downstream cable-modem link, and the user 95 cannot record the second digital television program or any other television program while the first television program is being displayed on the television 75;

(2) Tuning only to the second digital television program for recording the second digital television program. In such a case, the user 100 cannot use the downstream cable-modem link, and the user 95 cannot view the first digital television program or any other television program while the second digital television program is being recorded; and

(3) Providing the downstream cable-modem link for enabling downstream communication with the computer 80. In such a case, the user 100 can utilize the downstream cable-modem link and the computer 80 to perform operations such as web browsing, and downloading of data provided by the broadband communication network 25 to the storage device. However, the user 95 cannot view or record any digital television program.

In a configuration in which the STB 70 enables simultaneous tuning to the third digital television program, the STB 70 may additionally enable one of the following combinations:

(4) Tuning to the second digital television program for recording the second digital television program and tuning to the third digital television program for enabling viewing of the third digital television program by the user 95. In such a case, the user 95 can view the third digital television program and record the second digital television program simultaneously, but the user 100 cannot use the downstream cable-modem link while the second digital television program is being recorded; and

(5) Providing the downstream cable-modem link for enabling downstream communication with the computer 80 and tuning to the third digital television program for enabling viewing of the third digital television program by the user 95. In such a case, the user 100 can utilize the downstream cable-modem link and the computer 80 to perform operations such as web browsing and downloading of data provided by the broadband communication network 25 to the storage device, the user 95 can view the third digital television program, but the user 95 cannot record the second digital television program while the downstream cable-modem link is provided.

It is appreciated that in any of the combinations mentioned above the first digital television program and the second digital television program may be identical, or the third digital television program and the second digital television program may be identical.

Additionally in any of the combinations mentioned above, the STB 70 may report back an indication of availability resources of tuning, link provision, and/or storage by upstream transmission to at least one of the following: the headend 15; and the broadband communication network 25. In such a case, when, for example, the headend 15 receives such a report back, the headend 15 may be operative to program a tuning selection of the STB 70.

Preferably, when the downstream cable-modem link cannot be used, the user 100 may preferably receive on a display 105 of the computer 80 a message indicating that the downstream cable-modem link cannot be used during viewing and/or recording of any digital television program. Similarly, when recording of a digital television program cannot be used, the user 95 may preferably receive on the television 75 a message indicating that digital television recording is not available while the downstream cable-modem link is in use.

It is appreciated that the cable-modem may be used, for example, either with the Data Over Cable Service Interface Specification (DOCSIS) standard or the Digital Video Broadcasting Return Channel (DVB_RC) standard.

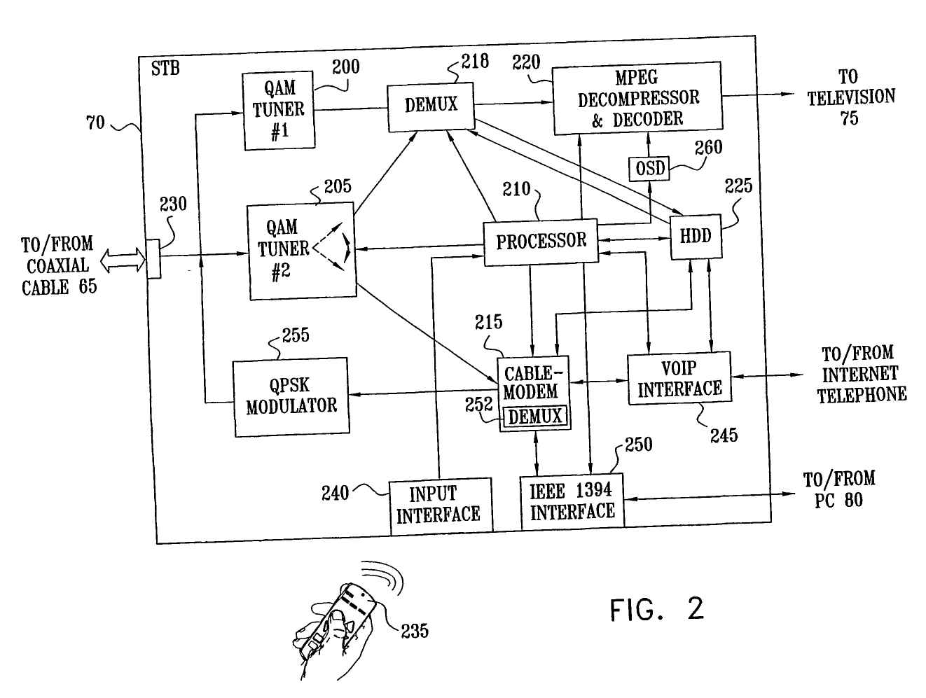

Reference is now additionally made to FIG. 2 which is a simplified block diagram illustration of a preferred implementation of the STB 70 in the SU 20 in the system 10 of FIG. 1.

Preferably, the STB 70 includes the following elements: a first quadrature amplitude modulation (QAM) based tuner 200; a second QAM based tuner 205; a controller, such as a processor 210; a cable-modem 215; a demultiplexing unit (DEMUX) 218; a decompressor and decoder unit 220; and a storage device such as a memory implemented in a hard-disk drive (HDD) 225. The decompressor in the unit 220 may preferably include a Moving Picture Expert Group (MPEG) based decompressor. Examples of suitable commercially available integrated circuits that include the functionality of the processor 210, the DEMUX 218 and the decompressor and decoder unit 220 in combination are: STMicroelectronics 5514; EMMA2 by NEC; and Europa by IBM.

In accordance with a preferred embodiment of the present invention the STB 70 may operate either with or without the QAM based tuner 200.

In a case where the STB 70 operates without the QAM based tuner 200, the QAM based tuner 205 preferably receives the multiplexed transmissions provided by the MUX/DEMUX unit 30 via the coaxial cable 65 and a coaxial port 230 which is also comprised in the STB 70. The second QAM based tuner 205 is preferably operatively controlled by the processor 210 to selectively enable shared use of the QAM based tuner 205 between the following two functions: tuning to a digital television frequency; and providing a downstream cable-modem link. The function of tuning to a digital television frequency may preferably include one of the following: tuning to a first digital television program for enabling viewing of the first digital television program by the user 95 of the SU 20; and tuning to a second digital television program for recording the second digital television program by the user 95. It is appreciated that the first digital television program and the second digital television program may be identical.

If the processor 210 instructs the second QAM based tuner 205 to tune to the digital television frequency, the second QAM based tuner 205 preferably tunes to the digital television frequency by performing QAM demodulation of the multiplexed transmissions. The DEMUX 218 then separates the first digital television program or the second digital television program from other television programs carried over the frequency. Typically, the first and second digital television programs are provided in a compressed form, such as in an MPEG form. Thus, if the first digital television program is separated, the first digital television program is preferably decompressed and decoded in the decompressor and decoder unit 220, for example by employing MPEG decompression and decoding, and provided to the television 75 for displaying thereon.

If the second digital television program is separated, the processor 210 preferably instructs the DEMUX 218 to provide the second digital television program to the HDD 225 for recording therein in a compressed form. When the user 95 enters a selection to view the second digital television program stored in the HDD 225, the processor 210, in response to the selection entered by the user 95, preferably retrieves the second digital television program from the HDD 225, and provides the second digital television program to the DEMUX 218. The DEMUX 218 then preferably separates the second digital television program from other television programs, and provides the second digital television program to the decompressor and decoder unit 220 for decompressing and decoding of the second digital television program, for example by employing MPEG decompression and decoding. The decompressor and decoder unit 220 then preferably provides the second digital television program to the television 75 for displaying thereon.

It is appreciated that selection of any of the functions enabled by tuning to the digital television frequency may preferably be performed, for example, by the user 95 operating a remote control 235, and entering commands and selections that are sensed by an input interface 240 in the STB 70. The input interface 240 is preferably operatively associated with the processor 210.

If the processor 210 instructs the second QAM based tuner 205 to provide the downstream cable-modem link, preferably in response to a selection made by the user 100, the second QAM based tuner 205 preferably provides the downstream cable-modem link by performing QAM demodulation of the multiplexed transmissions to separate a frequency used by the cable-modem 215 in the downstream over which downstream cable-modem applications provided by the broadband communication network 25 are carried. The term “downstream cable-modem application” is used throughout the specification and claims to refer to a broadband application used in the downstream by the computer 80 via the cable-modem 215.

It is appreciated that the downstream cable-modem applications may refer to a variety of broadband applications that may run on a computer such as a personal computer (PC), or on various electronic devices having processing capabilities such as a videophone, a VoIP (voice-over-internet-protocol) telephone, and a personal organizer. A downstream cable-modem application may thus include, for example, at least one of the following: a video-clip; a still image; and a VoIP session. In order to run the downstream cable-modem application, the STB 70 may therefore include at least one of the following optional elements: a VoIP interface 245; and an IEEE 1394 interface 250. The VoIP interface 245 is preferably operatively associated with an Internet telephone (not shown) that may be operated via the computer 80 or be embodied in a separate unit (not shown). The IEEE 1394 interface 250 is preferably operatively associated with the computer 80.

Preferably, as described above, the cable-modem 215 may be used, for example, either with the DOCSIS standard or the DVB_RC standard.

Once the second QAM based tuner 205 is enabled to provide the downstream cable-modem link, the cable-modem 215 may preferably employ a built-in demultiplexer 252 to separate a downstream cable-modem application selected by the user 100 from the rest of the broadband transmissions. It is appreciated that the user 100 may preferably select the downstream cable-modem application, for example, by selecting an icon displayed on the computer display 105 or entering a command.

The downstream cable-modem application selected by the user 100 is then preferably provided to the computer 80 where the downstream cable-modem application may, in response to a selection or an instruction entered by the user 100, be utilized. It is appreciated that utilization of the downstream cable-modem application may include, for example, downloading of the downstream cable-modem application to at least one of the following: the HDD 225; the Internet telephone via the VoIP interface 245; and the computer 80 via the IEEE 1394 interface 250.

In a case where the STB 70 operates with the first QAM based tuner 200, the first QAM based tuner 200 preferably receives the multiplexed transmissions provided by the MUX/DEMUX unit 30 via the coaxial cable 65 and the coaxial port 230 and performs QAM demodulation of the multiplexed transmissions for independently tuning to a digital television frequency over which a third digital television program, that the user 95 may either view or record, is carried. It is appreciated that the third digital television program and the second digital television program may be identical.

In such a case, the DEMUX 218 preferably separates the third digital television program from other television programs, and, if the user 95 chooses to view the third digital television program, the processor 210 preferably instructs the DEMUX 218 to provide the third digital television program to the decompressor and decoder unit 220. The decompressor and decoder unit 220 preferably decompresses and decodes the third digital television program, for example by employing MPEG decompression and decoding. The decompressor and decoder unit 220 then preferably provides the third digital television program in a decoded and decompressed form to the television 75 for displaying thereon.

If the user 95 chooses to record the third digital television program, the processor 210 preferably instructs the DEMUX 218 to provide the third digital television program to the HDD 225 for storage therein in a compressed form. When the user 95 enters a selection to view the third digital television program stored in the HDD 225, the processor 210, in response to the selection entered by the user 95, preferably retrieves the third digital television program from the HDD 225, and provides the third digital television program to the DEMUX 218. The DEMUX 218 then preferably separates the third digital television program from other television programs, and provides the third digital television program to the decompressor and decoder unit 220 for decompressing and decoding of the third digital television program, for example by employing MPEG decompression and decoding. The decompressor and decoder unit 220 then preferably provides the third digital television program to the television 75 for displaying thereon.

It is appreciated that since the first and second QAM based tuners 200 and 205 are not dependent on each other, the STB 70, in a configuration that includes both the first and second QAM based tuners 200 and 205, enables each of the combinations mentioned above with reference to FIG. 1. Furthermore, whereas the first and second QAM based tuners 200 and 205 execute similar functions with regard to digital television frequencies tuned thereto, the second QAM based tuner 205 additionally executes functions with regard to providing the downstream cable-modem link.

The STB 70 may also preferably include a quadrature phase shift keying (QPSK) based modulator 255 that is operatively associated with the cable-modem 215, and with the coaxial cable 65 via the coaxial port 230. The QPSK based modulator 255 preferably provides a permanent low bit-rate connection with the headend 15 and/or the broadband communication network 25 via the coaxial cables 65 and 45. It is appreciated that the QPSK based modulator 255 may be used to provide upstream communication regardless of whether the second QAM based tuner 205 is used for digital television or for providing the downstream cable-modem link.

The QPSK based modulator 255 is preferably operative to enable, inter alia, a report back of an indication of availability resources of the second QAM based tuner 205 by upstream transmission to at least one of the following: the headend 15; and the broadband communication network 25. The indication of availability resources preferably includes at least one of the following: an indication indicating whether the second QAM based tuner 205 is currently available; an indication indicating a time period within which the second QAM based tuner 205 is expected to be available; and an indication indicating an available storage capacity of the HDD 225.

Further in accordance with a preferred embodiment of the present invention, when the headend 15 receives the report back of the indication of availability resources of the second QAM based tuner 205, the headend 15 may program the processor 210 in the STB 70 to force-tune the second QAM based tuner 205 to a digital television program selected by the user 95 for storing the program in the HDD 225.

Preferably, the processor 210 may generate a message indicating that digital television recording cannot be used while the downstream cable-modem link is used. The processor 210 may preferably provide the message to an on-screen-display (OSD) 260 that preferably prepares the message for display on the television 75. Similarly, the processor 210 may generate a message indicating that the downstream cable-modem link cannot be used while digital television recording is used. This message may preferably be provided to the computer 80, for example via the IEEE 1394 interface 250, for display on the computer display 105.

In operation, the STB 70 preferably receives digital television programs and broadband information via the coaxial cable 65. The STB 70 may preferably selectively enable shared use of the QAM based tuner 205 between tuning to a digital television frequency that enables viewing of a selected digital television program or recording of the selected digital television program, and use of a downstream cable-modem link that enables operations to be performed on downstream broadband information.

In a configuration in which the STB 70 operates with the first QAM based tuner 200, the first QAM based tuner 200 may be tuned to another digital television program and therefore each of the combinations mentioned above with reference to FIG. 1 is enabled.

It is appreciated that operation of the second QAM based tuner 205 is preferably carried out based on a first-requested first-served logic. Thus, the downstream cable-modem link cannot be used as long as a digital television program is in a storage process, and a digital television program cannot be stored as long as the downstream cable-modem link is in use. Digital television recording can be performed either by the user 95 or according to an instruction transmitted from the headend 15.

It is appreciated that upstream communication may be carried out at all times regardless of an operation mode of the second QAM based tuner 205.

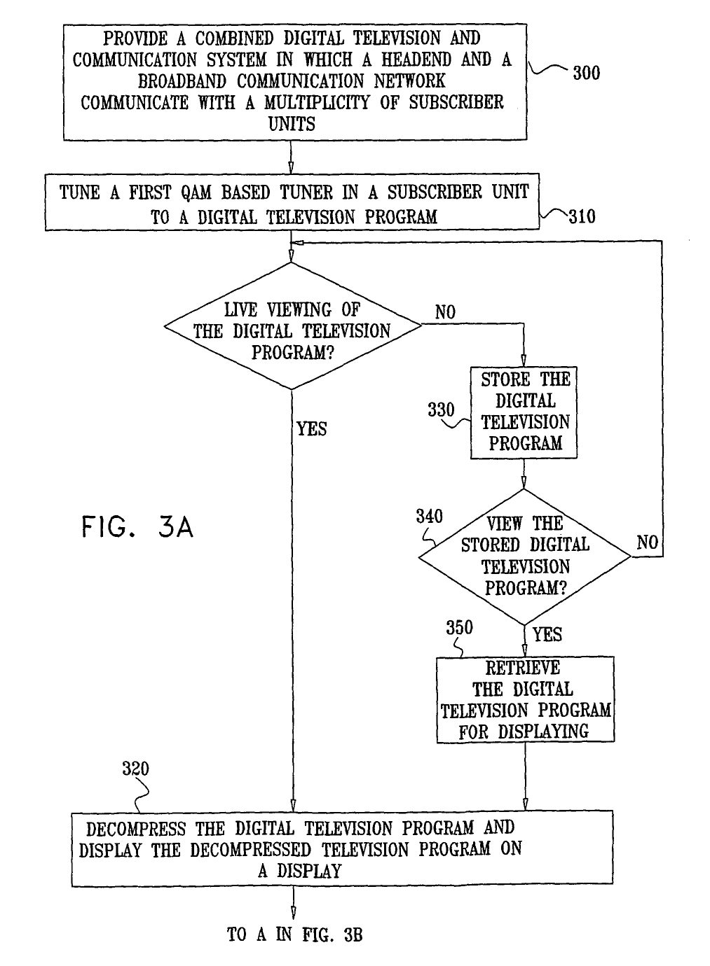

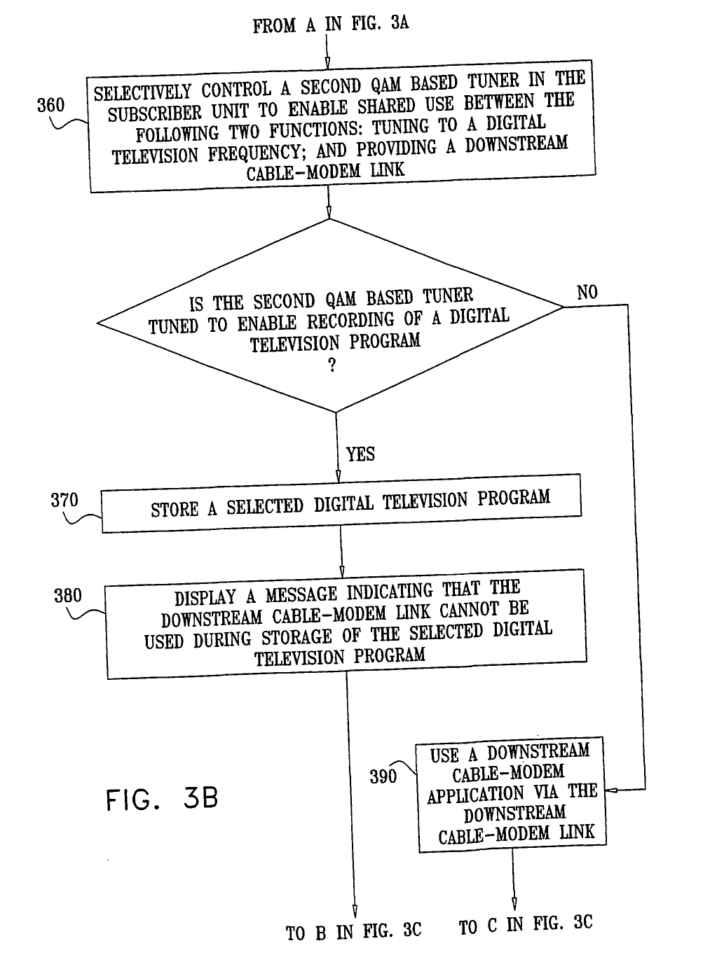

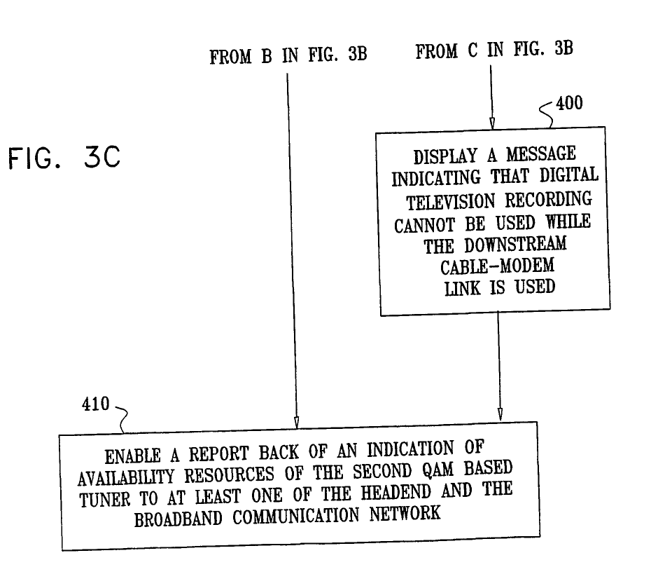

Reference is now made to FIGS. 3A-3C that together comprise a simplified flowchart illustration of a preferred method of operation of the apparatus of FIG. 2 in the system of FIG. 1.

A combined digital television and communication system in which a headend and a broadband communication network communicate with a multiplicity of subscriber units is preferably provided (step 300).

In a subscriber unit of the combined digital television and communication system, a first QAM based tuner is tuned to a digital television program for enabling viewing or recording of the digital television program by a user of the subscriber unit (step 310). If the first QAM based tuner is tuned so as to enable viewing of the digital television program, the digital television program is preferably decompressed (step 320) prior to displaying on a display.

If the first QAM based tuner is tuned so as to enable recording of the digital television program, the digital television program is preferably stored (step 330) in a memory in the subscriber unit. Then, if the user chooses to view the digital television program (step 340), the digital television program is retrieved (step 350) from the memory and decompressed prior to displaying on the display.

Additionally, a second QAM based tuner is selectively controlled to enable shared use between the following two functions: tuning to a digital television frequency; and providing a downstream cable-modem link (step 360). Preferably, the function of tuning to the digital television frequency includes one of the following: tuning to a first digital television program for enabling viewing of the selected digital television program by the user; and tuning to a second digital television program for enabling recording of the second digital television program by the user. The first and second digital television programs may be identical.

When the second QAM based tuner is tuned so as to enable recording of a selected digital television program, the selected digital television program is preferably stored (step 370). The selected digital television program may be either the digital television program tuned to by the first QAM based tuner and viewed by the user, or another digital television program selected by the user. Preferably, during a period in which the second QAM based tuner is tuned to enable digital television recording, a message indicating that the downstream cable-modem link cannot be used is displayed (step 380) at the subscriber unit.

When the second QAM based tuner provides the downstream cable-modem link, a downstream cable-modem application can preferably be used (step 390). A message indicating that digital television recording cannot be used while the downstream cable-modem link is used is then preferably displayed (step 400) at the subscriber unit.

It is appreciated that the subscriber unit may be used without the first QAM based tuner. In such a case, the functionality of the subscriber unit is limited to one of the following: viewing of a digital television program; recording of a digital television program; and using the downstream cable-modem link.

Preferably, a report back of an indication of availability resources of the second QAM based tuner to at least one of the headend and the broadband communication network is enabled (step 410) regardless of mode of operation of the second QAM based tuner. The indication of availability resources preferably includes at least one of the following: an indication indicating whether the second QAM based tuner is currently available; an indication indicating a time period within which the second QAM based tuner is expected to be available; and an indication indicating an available storage capacity of a storage device in the subscriber unit in which the selected digital television program and at least a portion of the downstream cable-modem application can be stored.

Preferably, the report back is provided by a permanent low bit-rate upstream communication link that enables communication with the headend and the broadband communication network. Preferably, a QPSK based modulator in the subscriber unit is used to enable the permanent low bit-rate upstream communication link.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined only by the claims which follow:

What is claimed is:

1. A set-top box (STB) in a subscriber unit of a combined digital television and communication system, the STB comprising:
a controller; and
a quadrature amplitude modulation (QAM) based tuner operatively controlled by the controller to selectively enable shared use of the QAM based tuner between the following two functions: tuning to a digital television frequency; and providing a downstream cable-modem link.

2. The STB according to claim 1 and wherein said function of tuning to a digital television frequency comprises one of the following: tuning to a first digital television program for enabling viewing of the first digital television program by a user of the subscriber unit; and tuning to a second digital television program for recording the second digital television program by the user of the subscriber unit.

3. The STB according to claim 2 and wherein said first digital television program and said second digital television program are identical.

4. The STB according to any of claims 1-3 and also comprising:
an additional QAM based tuner operative to tune to a third digital television program for enabling viewing of the third digital television program by a user of the subscriber unit.

5. The STB according to claim 2 or claim 3 and also comprising a storage device operative to store said second digital television program when said QAM based tuner is tuned to said second digital television program.

6. The STB according to any of claims 1-5 and also comprising a cable-modem operatively associated with said QAM based tuner and operative to enable downstream communication via said downstream cable-modem link when said QAM based tuner is enabled to provide said downstream cable-modem link.

7. The STB according to any of claims 1-6 and also comprising:
a quadrature phase shift keying (QPSK) based modulator operative to enable a report back of an indication of availability resources of said QAM based tuner by upstream transmission to at least one of the following: a headend of the combined digital television and communication system; and a broadband communication network in said combined digital television and communication system.

8. The STB according to claim 7 and wherein said indication of availability resources comprises an indication indicating whether the QAM based tuner is currently available.

9. The STB according to claim 7 and wherein said indication of availability resources comprises an indication indicating a time period within which the QAM based tuner is expected to be available.

10. The STB according to claim 5 and also comprising:
a quadrature phase shift keying (QPSK) based modulator operative to enable a report back of an indication of availability resources of said QAM based tuner by upstream transmission to at least one of the following: a headend of the combined digital television and communication system; and a broadband communication network in said combined digital television and communication system,
said indication of availability resources comprising an indication indicating an available storage capacity of said storage device.

11. The STB according to any of claims 2, 3, 5 and 10 and wherein each said first digital television program and said second digital television program is received at the STB in a compressed form, and the STB also comprises a decompressor operatively associated with said QAM based tuner and operative to decompress each said first digital television program and said second digital television program.

12. The STB according to claim 11 and wherein said decompressor comprises a Moving Picture Expert Group (MPEG) based decompressor.

13. The STB according to any of claims 2, 3, 5 and 10 and wherein said controller is operative generate a message indicating that said downstream cable-modem link cannot be used while said QAM based tuner is tuned to said second digital television program, and a message indicating that said second digital television program cannot be recorded while said QAM based tuner is enabled to provide said downstream cable-modem link.

14. A set-top box (STB) in a subscriber unit of a combined digital television and communication system, the STB comprising:
a first quadrature amplitude modulation (QAM) based tuner operative to tune to a digital television program for enabling viewing of the digital television program by a user of the subscriber unit;
a controller; and
a second QAM based tuner operatively controlled by the controller to selectively enable shared use of the second QAM based tuner between the following two functions: recording the digital television program; and providing a downstream cable-modem link.

15. A combined digital television and communication system comprising:
a headend operative to broadcast digital television programs;
a broadband communication network operative to transmit a downstream cable-modem application; and
a multiplicity of subscriber units, each comprising:
a first QAM based tuner operative to tune to a first digital television program of said digital television programs broadcast by said headend;
a decompressor operatively associated with said first QAM based tuner and operative to decompress said first digital television program prior to displaying of the first digital television program on a display;
a controller;
a second QAM based tuner operatively controlled by the controller to selectively enable shared use of the second QAM based tuner between the following two functions: tuning to a second digital television program of said digital television programs broadcast by said headend for recording said second digital television program, and tuning to the downstream cable-modem application;
a cable-modem operative to enable use of the downstream cable-modem application when said second QAM based tuner is tuned to said downstream cable-modem application; and
a storage device operative to store said second digital television program when said second QAM based tuner is tuned to said second digital television program.

16. The system according to claim 15 and wherein said first digital television program and said second digital television program are identical.

17. The system according to claim 15 or claim 16 and wherein each of said multiplicity of subscriber units also comprises a QPSK based modulator operative to enable a report back of an indication of availability resources of said second QAM based tuner by upstream transmission to at least one of the following: said headend; and said broadband communication network.

18. The system according to claim 17 and wherein said headend is operative, upon receiving said report back from at least one said controller, to program said at least one said controller to tune said second QAM based tuner to said second digital television program for storing said second digital television program.

19. A method for use with a set-top box (STB) in a subscriber unit of a combined digital television and communication system, the method comprising:
selectively enabling shared use of a quadrature amplitude modulation (QAM) based tuner between the following two functions: tuning to a digital television frequency; and providing a downstream cable-modem link.

20. The method according to claim 19 and wherein said function of tuning to a digital television frequency comprises one of the following: tuning to a first digital television program for enabling viewing of the first digital television program by a user of the subscriber unit; and tuning to a second digital television program for recording the second digital television program by the user of the subscriber unit.

21. The method according to claim 20 and also comprising storing said second digital television program when said QAM based tuner is tuned to said second digital television program.

22. The method according to claim 21 and also comprising:
displaying a message indicating that said downstream cable-modem link cannot be used during said storing.

23. The method according to any of claims 19-22 and also comprising:
enabling downstream communication via said downstream cable-modem link when said QAM based tuner is enabled to provide said downstream cable-modem link.

24. The method according to any of claims 20-22 and also comprising:
enabling usage of said downstream cable-modem link when said QAM based tuner is enabled to provide said downstream cable-modem link; and
displaying a message indicating that said second digital television program cannot be recorded while said downstream cable-modem link is used.

25. The method according to any of claims 19-24 and also comprising:
enabling a report back of an indication of availability resources of said QAM based tuner to at least one of the following: a headend of the combined digital television and communication system; and a broadband communication network in said combined digital television and communication system.

26. The method according to claim 25 and wherein said indication of availability resources comprises an indication indicating whether the QAM based tuner is currently available.

27. The method according to claim 25 and wherein said indication of availability resources comprises an indication indicating a time period within which the QAM based tuner is expected to be available.

28. The method according to claim 25 and wherein said indication of availability resources comprises an indication indicating an available storage capacity of a storage device within which a digital television program accessed when said QAM based tuner is tuned to said digital television frequency can be stored.

29. A method for use with a set-top box (STB) in a subscriber unit of a combined digital television and communication system, the method comprising:
tuning a first QAM based tuner to a digital television program for enabling viewing of the digital television program by a user of the subscriber unit; and
selectively enabling shared use of a second QAM based tuner between the following two functions: recording the digital television program; and providing a downstream cable-modem link.

30. The method according to claim 29 and also comprising decompressing said digital television program.
